(19) United States
(12) Patent Application Publication
(10) Pub. No.: US 2018/0264664 A1
(43) Pub. Date: Sep. 20, 2018

(54) TRAVEL RAZOR

(71) Applicant: Sphynx Collection, LLC, Los Angeles, CA (US)

(72) Inventor: Leila Kashani Manshoory, Los Angeles, CA (US)

(21) Appl. No.: 15/459,734

(22) Filed: Mar. 15, 2017

(51) Int. Cl. B26B 21/40; B26B 21/44; B26B 21/52; B26B 21/22

(52) U.S. Cl. CPC B26B 21/4012; B26B 21/4037; B26B 21/225; B26B 21/521; B26B 21/446

(57) ABSTRACT

A portable razor is disclosed, comprising a razor blade, a water container, a shaving lubricant, and a cover to prevent the razor from making a mess when carried in a pocket or purse. The portable razer is further equipped with an element indicator configured to indicate the position of at least one of the functional elements within the housing. Such a razor may be used while on-the-go while still keeping the advantages of a real shave with soap and water.

### BACKGROUND

Shaving is a normal part of life for both men and women. While most people shave in the bathroom or the shower as part of their normal routine, occasionally people require a razor while on-the-go. For example, a woman may notice an area she missed while shaving in the morning, and require a touch-up; a woman may be simply too busy to shave or have forgotten to shave that morning; a traveling professional may require a portable razor for a quick shave at the airport before an important meeting; and so on. All of those applications require a razor that is readily available and easy to use on the go.

For this reason, many women carry a standard razor with them and dry-shave when the need arises. However, dry-shaving irritates the skin and does not deliver a close shave. For a closer and less irritating shave, water and soap or other shaving lubricant are needed. However, it is cumbersome and inconvenient for a user to carry water, soap, and a razor when out and about. A need exists for a portable razor that incorporates water and a shaving lubricant in a way that more faithfully duplicates the home shaving experience.

### SUMMARY OF THE INVENTION

An object of the present invention is to provide a portable razor that supplies a water source, a shaving lubricant, and at least one razor blade in a portable, leak-proof package that can be easily carried.

In an embodiment, the present invention comprises a body, a razor blade attached to the body, a shaving lubricant attached to the body, and a water container with a sprayer attached to the body. The razor blade is preferably removable and replaceable, as is the shaving lubricant. The water container is preferably refillable. In an embodiment, a second razor blade is also attached to the body.

In an embodiment, the razor blade (or razor blades) is retractable into the body when not in use. The present invention may also comprise a razor cap covering the razor blade when not in use.

In an embodiment, the shaving lubricant is a soap bar. The soap bar may be retractable into the body; the present invention may also comprise a soap bar cap covering the soap bar when not in use.

In an embodiment, the water container is refillable. The shaving lubricant may also be refillable.

In the preferred embodiment, the present invention comprises a housing that comprises an axis of rotation, and an opening. An inner body is located within the housing, and is mounted in such a way as to rotate around the axis of rotation. A first razor blade, a shaving lubricant, and a water sprayer are mounted on the inner body in such a way as to be exposed through the opening when the inner body is rotated. The water sprayer is connected to a water container. The present invention also comprises a cap to cover the opening.

In an embodiment, a second razor blade is also mounted on the inner body in such a way as to be exposed through the opening when the inner body is rotated.

The shaving lubricant is preferably a soap bar. In the preferred embodiment, the soap bar is removable. Other shaving lubricants may also be used.

The water container is preferably refillable, and may also be removable for easier refilling.

The inner body is preferably triangular, but may also be rectangular if a second razor blade is included. Any other shape may be used as long as it permits the razor blade or blades, the shaving lubricant, and the water sprayer to be exposed through the opening when the inner body is rotated. The portable razor may be configured such that in order to switch from one functional element such as the first razor blade, the second razor blade, the shaving lubricant and the water sprayer to another one, a rotation of approximately 360°/n of the inner body about the axis of rotation may be required, wherein n corresponds to the number of functional elements.

The housing is preferably round, but may be any other shape as long as the inner body may rotate freely within it and the razor blade or blades, shaving lubricant, and water sprayer are exposed when the inner body is rotated.

In an embodiment, the present invention may also comprise a razor cleaning device for cleaning stray hairs out of the razor during shaving.

In an embodiment, the housing may include at least one opening fitted to receive a circular protrusion which is arranged on the inner body of the travel razor. In some embodiments, the protrusion may be formed integrally with the inner body. The protrusion may reside in the opening of the housing and may be rotatable by the user in order to rotate the inner body within the housing. The protrusion may be one with respect to the surface of the inner body but not with respect to the surface of the housing. That is, the protrusion may be formed such that it does not protrude from a steady continuation of the outer surface of the housing in the region of the opening. The outer surface of the protrusion facing away from the travel razor (i.e. facing outside) may comprise indentations, protrusions or other structures forming portions which can be grasped easily. The outermost portions of the outer surface of the protrusion facing outside may be consistent with a steady continuation of the outer surface of the housing in the region of the opening. Such a configuration may be advantageous in that the travel razor may be placed on any surface such as a table or a shelf in a lying position, i.e. with the axis of rotation being perpendicular to that surface, in a stable manner without any wobbling due to elements protruding from the surface of the housing in contact with the underlying surface.

In a further embodiment, the travel razor may include a locking mechanism to lock the position or orientation of the inner body within the housing. In other words, the locking mechanism may be configured to prevent accidental or unwanted rotation of the inner body within the housing. An accidental or unwanted rotation of inner body within the housing may take place, for example, when the razor is in “transport mode”, i.e. with the cap fitted to the housing, or when the razor is being used.

According to one embodiment, the locking mechanism may be based on a ratchet, with a gear mounted to the inner body and a pawl mounted on the inside of the housing. The pawl may be biased against the gear to provide perceptible resistance when the inner body is to be rotated from one positon to the next one in order to provide a more stable locking of a selected functional element, i.e. an element arranged or exposed at the opening.

In a further embodiment, the locking mechanism may be implemented by means of locking members. The locking mechanism may be implemented by at least one first locking member which is configured to be brought into locking or intimate arrangement with a second locking member. Preferably, the locking mechanism may be configured such that a pressure needs to be exerted on the circular protrusion (or at least on one of the circular protrusions if two are present) along the axis of rotation before the inner body can be rotated relative to the housing. In an exemplary embodiment, the first locking member may be a protrusion, e.g. a land, arranged on the circular protrusion and the second locking member may be a correspondingly shaped depression, e.g. a groove, provided on the inner side of the housing. It is to be noted that the nature of the first and second locking members as protrusion and depression may be exchanged.

In a locked state, the first locking member and the second locking member may be preset in a locking arrangement in order to lock or secure a predefined position of the inner body within the housing against rotation. A predefined positon of the inner body within the housing may be any position in which one of the functional elements is provided or exposed at the opening ready for use. An exemplary locked state, for example, may include the first locking member being biased into the second locking member by an elastic element, such as a spring or an elastic piece of material or by a general resiliency of the first locking member or the portion it is arranged on.

Depending on the nature of the locking mechanism, the locked state may be unlocked, for example, by applying pressure along the axis of rotation on the (one or two) circular protrusion(s), such that the first locking member and the second locking member may disengage from the locking arrangement in order to allow the inner body to rotate freely within the housing 100. The user may then rotate the inner body to in order to position the desired functional element in the opening for use. In another embodiment, the locked state may be unlocked by applying a rotation force on the circular protrusion which is sufficient to overcome the frictional force keeping the first locking member in locking engagement with the second locking member.

In general, the number of first locking members does not have to correspond to the number of second locking members. That is, only one first locking member or only one second locking member may be provided, for example, while more second locking members and first locking members, respectively, may be provided. The number of the corresponding other locking members may correspond to the number of functional elements provided on the inner body. For example, when there are four functional elements provided on the inner body of the travel razor of the present invention, as stated above, one first locking member may be provided, for example aligned with the water sprayer, while accordingly four second locking members may be provided on the inside of the housing, each one representing one of the four functional elements.

The locking mechanism based on locking members may allow rotation of the inner body in both directions starting at any position. In a further embodiment, for ease of establishing locking arrangement between the locking members, the second locking member (receiving locking member, e.g. the depression) may have a tapered shape with a broad base adapted for intimate engagement with the outer surface of the first locking member (penetrating locking member, e.g. the land). As soon as the narrow portion such as a tip of the first locking member is rotated into the region of the broad base of the second locking member, it may be brought into intimate engagement with the second locking member more easily by sliding into its end position along and guided by the tapered walls of the second locking member, optionally at least partly effected by the biasing force of the elastic element.

In a further embodiment, the portable razor may comprise an element indicator configured to indicate the position of at least one of the functional elements, in particular when the cap is covering the opening such that the selected functional element cannot be identified visually. In this context, the position of at least one of the functional elements may be understood as the position of the functional element within the housing which depends on the orientation of the inner body to which the functional elements are attached to. For example, if four functional elements are attached to the inner body, each of the positions may be separated from one another by 90°.

The element indicator may include at least one element and be of visual, acoustic or haptic nature, wherein combinations are also included, such as symbols which may be perceived both visually and haptically. A visual implementation thereof may, for example, include at least one symbol representing a functional element, which is arranged on the outer surface circular protrusion such that it can be readily viewed from the outside. By looking at the circular protrusion and identifying the positions of the symbols thereon, the relative orientation or position of each functional element within the housing may be readily obtained without taking off the cap. However, the at least one symbol representing a functional element may be arranged on a portion of the circular protrusion arranged inside the housing. In such a case, one or more openings may be provided in the housing through which the at least one symbol may be viewed in the form of a “slide show”. For example, an opening may be arranged between the circular protrusion and the cap such that it is indicated which functional element is currently in place to be used once the cap has been removed. However, further openings may be provided in the housing, for example separated by 90° from one another, in case of four functional elements, such that it may be readily determined which functional element is arranged at which position inside the housing of the portable razor. Alternatively, only the position of one particular functional element, for example the water sprayer, may be indicated visually by any kind of visual mark arranged on the circular protrusion readily visible from outside or through a corresponding opening in the housing of the travel razor. This may be advantageous since the water sprayer is the functional element which will be used at the beginning of the shaving procedure. In general, the possibility to immediately identify the position of a certain functional element, in particular the water sprayer, may be also advantageous in airport situations when the water container has to be removed, since its position does not have to be searched with the cap removed, thus exposing the other functional elements (e.g. soap bar and razor blade) to the surrounding atmosphere.

A haptic implementation of the element indicator may include elements which are perceivable by tactile sense, such as rough, engraved or embossed elements. As stated above, the haptic nature of elements may be advantageously combined with visually perceptive nature. These elements may be provided on the circular protrusion such that they may be felt by the user and thereby convey to the user the current position of at least one functional element. For example, a number of haptic items such as dots or lands may be allocated to each of the functional elements and be arranged on the outer surface of the circular protrusion in a region lying between the center of the circular protrusion and the respective functional element. The number of the haptic elements used to indicate a respective functional element may, for example, represent its order during use in the shaving procedure (i.e. the water sprayer marked by one haptic element, the soap bar marked by two haptic elements, the razor blade marked by three haptic elements). In that sense, the haptic elements may be provided in groups, each group comprising a different number of haptic elements. The number of groups may correspond to the number of functional elements attached to the main body.

In a further embodiment, the travel razor may be configured to provide acoustic feedback when a functional element has been arranged in the opening. The acoustic feedback mechanism may be configured to generate a sound, e.g. a clicking sound, when a functional element has been arranged in the opening. In an exemplary embodiment, an indicative sound may be generated when the inner body has been rotated such that a functional element, e.g. the water sprayer, is placed in the opening. The sound may be generated, for example, by means of a metal or plastic platelet or string which is stricken or may be inherently generated by means of the locking mechanism. The acoustic feedback may be generated for all functional elements or only in respect of one or more predetermined functional elements. For example, acoustic indication of the first functional element to be used in the shaving procedure, i.e. the water sprayer, may be advantageous when the shaving procedure is to be performed in badly lit surrounding, e.g. at night, since the functional elements may be selected by sound without having to open the cap and inspect visually or by touch which functional element is currently in the position to use, i.e. arranged in the opening.

In a further embodiment, the travel razor may be configured such that it may not be possible to snap the cap onto the housing at all times. In other words, the travel razor according to the present invention may be provided with a predefined or favored closed state, i.e. a favored or predefined state in which the cap may be snapped onto the housing, e.g. after use of the device and before it is stored away. The predefined end state may include a predefined position/orientation of the inner body within the housing. For example, such a configuration may be used to prevent situations in which the razor blade is present in the opening and the cap to be placed thereon. Such a situation may be unwanted as it leads to the razor blade being arranged in the opening when the cap is removed from the housing next time in order to use the travel razor. Therefore, a portion of the inner body supporting the razor may be formed such that it prevents the cap from being snapped to the housing. In particular, the portion of the inner body on which the razor is arranged may comprise portions of material which interfere with portions of material of the cap, thus preventing placement of the cap on the housing.

In a further embodiment, the cap may be configured such that it prevents rotation of the inner body when it is snapped onto the housing. For this purpose, the cap may comprise at least one wedge portion which, once the cap is placed over the opening, engages or interacts with the inner body in such a manner that a rotation of the inner body is prevented. In particular, in in connection with the previous embodiment, the portion of the inner body supporting the razor may include portions of material at sites which would be occupied by the wedge portions of the cap when it is placed on the housing. In embodiments in which the travel razor is provided with the locking mechanism, the at least one wedge portion may be a protrusion or elongated portion of any kind which may block the circular protrusion from being pushed into the housing thereby unlocking the locking mechanism or block the gear of the ratchet such that it cannot be rotated.

In a further embodiment, the housing may comprise ventilation perforations. The ventilation perforations may be arranged along the outer edge of the housing. One group of ventilation perforations may be provided along the right side of the outer edge of the housing and a further group of ventilation perforations may be provided along the left side of the outer edge of the housing, when the position of the cap snapped to the housing defines the top of the housing. The one group of ventilation perforations may be arranged diametrically opposed with respect to the other group of ventilation perforations. The ventilation perforations may be used to dehumidify the interior of the housing. A diametrically opposed arrangement of two groups of perforations may be advantageous in that, at least in some situations, a draft effect may be induced such that the interior of the housing may dehumidify at a faster rate.

In embodiments of the travel razor which are provided with a predefined closed state, the predefined closed state may be used to force certain positions of the functional elements relative to the housing before the cap is allowed to be snapped onto the housing to be stored away. After the shaving procedure has been performed, it may be advantageous if, for example, the shaving lubricant is arranged proximate to one group of ventilation perforations and/or the razor is arranged proximate to the other group of ventilation perforations. Such an arrangement may be advantageous in that it may cause humidity to be carried away faster from functional elements arranged in close proximity to the ventilation perforations, thus extending their integrity and applicability.

### LIST OF FIGURES

FIG. 1 shows the preferred embodiment of the travel razor of the present invention with the cap on.

FIGS. 2A-2C show the preferred embodiment of the travel razor of the present invention with the cap off.

FIG. 3 shows a view of the inner body of the travel razor of the present invention.

FIG. 4 shows an exploded view of the inner body of the travel razor of the present invention.

FIG. 5 shows a schematic view of the inner body of the travel razor according to the present invention.

### DETAILED DESCRIPTION OF THE PREFERRED EMBODIMENT

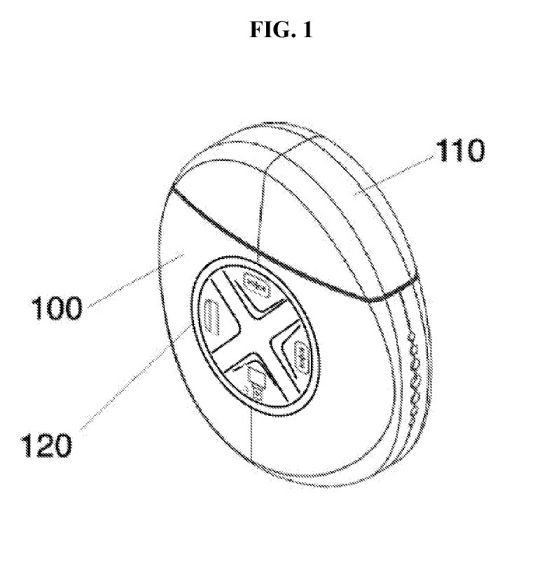

FIG. 1 shows the housing 100 of the razor of the preferred embodiment of the present invention, with the removable cap 110 on. The cap 110 is preferably tightly fitted to the housing 100 to prevent accidental leaks. In an embodiment, the fit between the cap 110 and the housing 100 is watertight. In the preferred embodiment, the cap 110 snaps onto the housing 100 in a way that would prevent it from becoming accidentally dislodged while being carried in a pocket or purse. As shown in the Figure, housing 100 comprises a circular hole; a circular protrusion 120 on the inner body of the razor is inserted in the circular hole such that it is accessible from the outside and able to rotate within the circular hole. The circular protrusion 120 is formed as a center dial including symbols 510-540 (see FIG. 5 for more details) which indicate the corresponding functional elements. In the preferred embodiment, such circular protrusions and circular holes are present on both sides of the razor. This locks the inner body within the housing and enables it to rotate freely within the housing. The circular protrusion may be formed such that it may be easily gripped with fingers for ease of rotation. As shown in the Figures, it may comprise four depressions, each depression labelled with a symbol 510-540, wherein the depressions are separated from one another by an elevated x-shaped structure. The circular protrusion 120, while protruding from the inner body 110, may be formed such that it is overall level with the surface of the housing 100 around the circular hole.

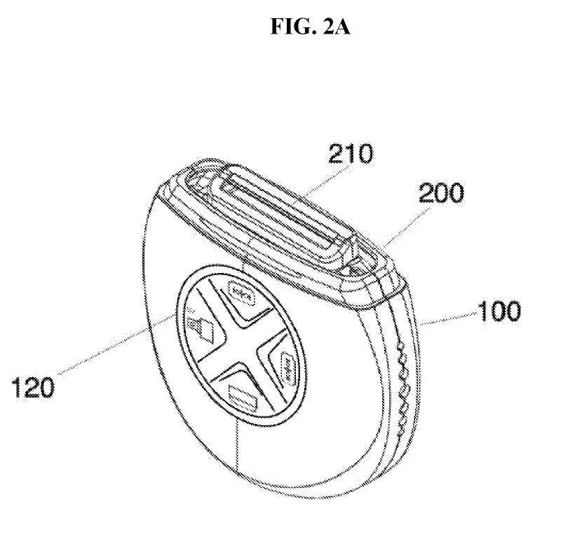

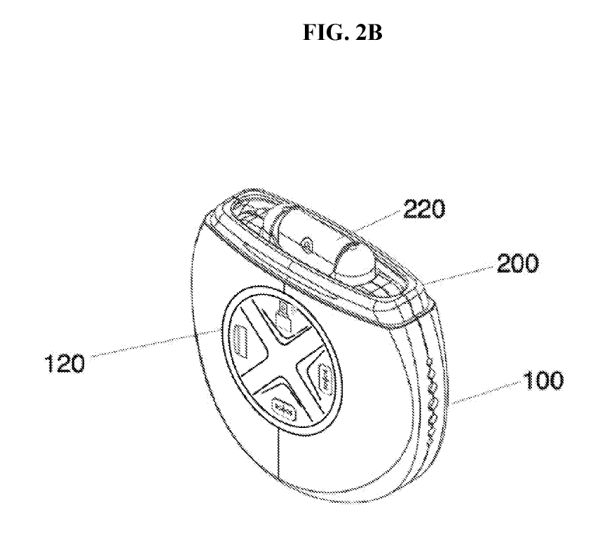

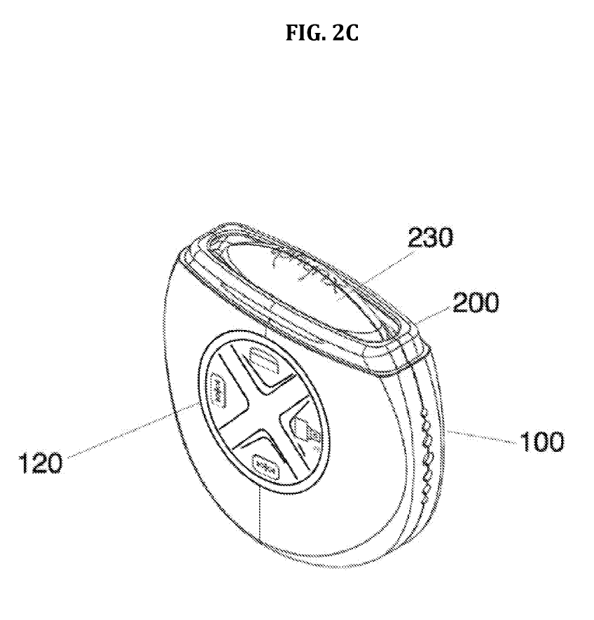

FIGS. 2A-2C show the razor of the preferred embodiment of the present invention with the cap off and with different attachments showing through the opening 200 in the housing 100. In the preferred embodiment, the inner body of the travel razor of the present invention comprises two razor blades, a water sprayer, and a soap bar. Any other number of razor blades may be used depending on user needs. A user can rotate any of those attachments into position by rotating the circular protrusion 120. FIG. 2A shows one of the razor blades 210 showing through the opening; FIG. 2B shows the water sprayer 220 showing through the opening; and FIG. 2C shows the soap bar 230 showing through the opening.

A user would preferably use the razor of the preferred embodiment of the present invention by taking off the cap, using the water sprayer 220 to spray some water on the area that requires a touch-up shave, then rotating the soap bar 230 into position and soaping up the area, and then rotating one of the razor blades 210 into position to shave the area. This enables the user to get a close shave of the same quality they would get when shaving at home, with no irritation or dry skin.

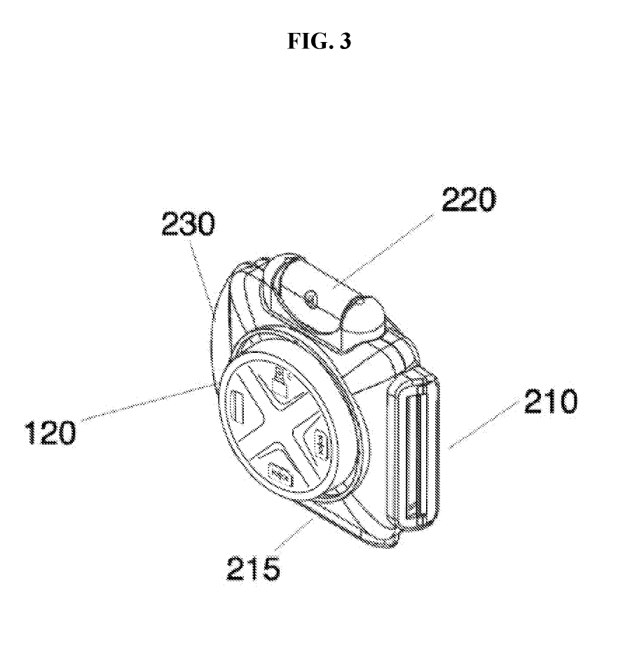

FIG. 3 shows a view of the inner body of the razor of the present invention. In the preferred embodiment, the inner body has four sides. A first razor blade 210 is mounted on one of the sides, and a second razor blade 215 is mounted on another side, as shown in the Figure. In the preferred embodiment, the razor blades are standard blade cartridges such as used in women's razors, and are removable and replaceable.

The third side of the inner body is taken up by a shaving lubricant 230. In the preferred embodiment, the shaving lubricant is a solid bar of soap or specialized shaving soap, as shown in FIG. 3. The shaving lubricant is preferably removable and replaceable. In an embodiment, a user may be able to choose from several different varieties of shaving lubricant to install in the present invention, differing in softness, scent (or unscented), moisturizing properties, and so on. In an embodiment, the shaving lubricant is a moisturizer that is easily absorbed by the skin (so that the user would not need to wash it off after shaving).

The fourth side of the inner body is taken up by a water sprayer 220, connected to a water container. The water sprayer 220 is preferably a standard sprayer that is leakproof and that can deliver a sufficient amount of water to the skin in a fine mist that does not cause dripping.

The middle of the inner body comprises a circular protrusion 120 that enables the inner body to be rotated with respect to the housing. In the preferred embodiment, the inner body “snaps” into position when each one of the attachments is positioned in the opening. In the preferred embodiment, the inner body comprises two circular protrusions 120, one on each side. This facilitates rotation.

In alternate embodiments, the circular protrusion 120 can comprise a handle or key that facilitates rotation.

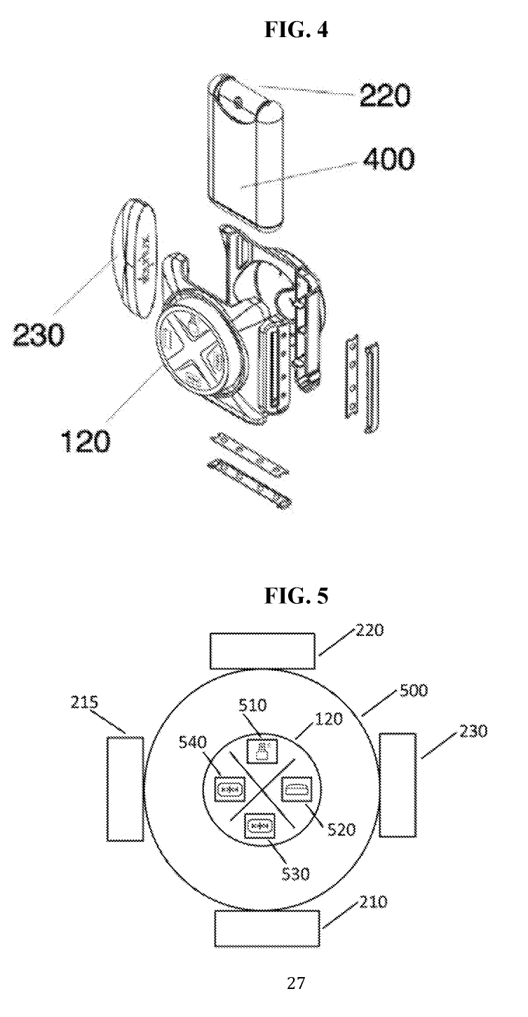

FIG. 4 shows an exploded view of the inner body. As can be seen in the Figure, the water sprayer 220 is connected to a water container 400 that preferably can contain a sufficient amount of water for at least one brief shave. The water container 400 is preferably lightweight and leakproof. In an embodiment, the water container is refillable, and may be opened. In another embodiment, the water container is disposable and cannot be opened.

As shown in FIG. 4, the shaving lubricant 230 is a solid bar that attaches to the inner body by a friction fit. Other methods of mounting the shaving lubricant 230 in the inner body are also possible.

As shown in particular in FIGS. 1-4, a first group of ventilation perforations is provided in the right side of the housing 100. A second group of ventilation perforations may be also provided on the other side of the housing 100, arranged opposite to the first group of ventilation perforations.

FIG. 5 shows a schematic of the inner body 500 of the travel razor according to a further embodiment of the present invention which is based on the view as shown in FIG. 3. As shown, the inner body 500 has four sides, wherein each side is defined by the edge of a segment of the inner body 500. A functional element is attached to each side of the inner body 500, i.e. the first razor blade 210 is mounted on one of the sides, and a second razor blade 215 is mounted on another side. The other two sides are occupied by the water sprayer 220 and the soap bar 230. The circular protrusion 120 comprises an element indicator in the form of four symbols or indicia 510-540, each one allocated to one functional element. The indicia 510-540 may be graphical symbol, which may in addition be of haptic nature such that they can be felt by a fingertip of a user. As already stated, in other embodiments the number and the location of the symbols 510-540 may differ from the embodiment shown in FIG. 5.

The above description is that of the preferred embodiment. Other embodiments of the invention are also possible and are limited solely by the appended claims.

1. A travel razor, comprising:
a housing, said housing comprising an axis of rotation, said housing comprising an opening;
an inner body, said inner body located within the housing, said inner body mounted within the housing in such a way as to rotate around the axis of rotation;
a first razor blade as a functional element mounted on the inner body in such a way as to be exposed through the opening when the inner body is rotated;
a shaving lubricant as a functional element mounted on the inner body in such a way as to be exposed through the opening when the inner body is rotated;
a water container mounted within the inner body;
a sprayer as a functional element connected to the water container, said sprayer mounted on the inner body in such a way as to be exposed through the opening when the inner body is rotated;
a cap to cover the opening; and
an element indicator configured to indicate the position of at least one of the functional elements within the housing.

2. The travel razor of claim 1, further comprising:
at least one second razor blade mounted on the inner body in such a way as to be exposed through the opening when the inner body is rotated.

3. The travel razor of claim 1, where the shaving lubricant is a soap bar.

4. The travel razor of claim 1, where the first razor blade is removable.

5. The travel razor of claim 1, where the water container is at least one of the following: refillable, removable.

6. The travel razor of claim 1, where the shaving lubricant is refillable.

7. The travel razor of claim 1, where the housing is round.

8. The travel razor of claim 1, where the inner body is triangular.

9. The travel razor of claim 2, where the inner body is rectangular.

10. The travel razor of claim 1, further comprising:
a razor cleaning device.

11. The travel razor of claim 1, further comprising:
a razor cleaning device.

12. The travel razor of claim 1, wherein the element indicator comprises at least one symbol representing a corresponding functional element.

13. The travel razor of claim 12, wherein the at least one symbol is arranged on a portion of the inner body protruding from the housing.

14. The travel razor of claim 12, wherein the at least one symbol is arranged on a portion of the inner body located inside the housing.

15. The travel razor of claim 14, further comprising at least one opening provided in the housing, the opening being arranged such that the at least one symbol may be viewed therethrough when the inner body is rotated to a predefined orientation.

16. The travel razor of claim 1, wherein the element indicator comprises haptic elements which are perceivable by tactile sense.

17. The travel razor of claim 16, wherein the haptic elements comprise at least one of rough elements, engraved elements and embossed elements.

18. The travel razor of claim 16, wherein the haptic elements are provided in groups, each group comprising a different number of haptic elements.

19. The travel razor of claim 11, wherein the travel razor may be configured to provide acoustic feedback when a predetermined functional element has been arranged in the opening.

20. The travel razor of claim 1, wherein the cap is configured such that, when the cap is in place over the opening, it prevents rotation of the inner body.

21. The travel razor of claim 20, wherein the cap comprises at least one wedge portion which, when the cap is in place over the opening, interacts with the inner body in such a manner that a rotation of the inner body is prevented.
